(19) United States
(12) Patent Application Publication
(10) Pub. No.: US 2004/0042023 A1
(43) Pub. Date: Mar. 4, 2004

(54) User operated print control

(76) Inventor: Susanne M. Gallivan, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/234,751

(22) Filed: Sep. 4, 2002

(51) Int. Cl. H04N 1/58; H04N 1/60

(52) U.S. Cl. 358/1.9; 358/504; 358/3.27

(57) ABSTRACT

In a visual output system that produces a graphic output, particularly a color printer, input data is to be produced in the graphic output according to nominal, potentially-calibrated operation of the system. However, a user-operated control input is provided, and is coupled to one or more of the variable signal, the print mechanism and the controller. The user-operated control input is used manually to modify a relationship between the input data and the actual graphic output, permitting the user to cause the graphic output to diverge from the calibrated color definition, for artistic or any other reasons.

### FIELD OF THE INVENTION

The invention relates to the field of printers.

### BACKGROUND OF THE INVENTION

The output of a color printer, like that of some other graphic apparatus, is an array of small points, each of which can have an independently selected and numerically encoded appearance. This appearance includes a value in a range or “gamut” of possible values that determine the color or hue and its intensity. The color attributes at each smallest defined point (generally called a picture element or pixel) are obtained by superimposing the corresponding amount and relative proportions of a limited set of constituent colors.

In a printer, the constituent colors typically are three primary colors obtained from inks or pigments. Constituent colors may be different in different situations, for example being red-blue-green versus cyan-yellow-magenta, depending on whether the colors tend to superimpose and add, versus to filter and subtract from one another.

In a data processing system, stored data values encode an appearance for every smallest defined point or pixel, which is one measure of resolution. Another measure of resolution is the precision or number of bits with which the color value of a single pixel is encoded. These possible color values can be considered as one measure of the character or quality of the output of the apparatus. Another value that is independent of precision is the accuracy of the color value, i.e., the extent to which a pixel's appearance is an accurate reproduction of the appearance that is supposed to result from printing a pixel having a given encoded value.

There are many possible techniques for superimposing colors. The structure and operation of the output device, for example a color printer, determines the nature of the display produced. Print output devices may have controllable ink or pigment emitting devices, thermal or impact elements, electrostatic toner application mechanisms, etc. Using electrical and electromechanical controls and actuators, software drivers produce the output, namely by converting the color definition coding into signals that operate the actuators in a manner that is expected to reproduce color attributes represented by data values that are stored or generated to define the visual output color attributes for each pixel.

The data values that encode pixel appearance attributes are based upon ideal standards. Printers and their software drivers are designed to reproduce encoded colors accurately insofar as possible. Therefore, at least ideally, the same data values when used to generate an output on the same apparatus at different times, as well as on different apparatus, will have substantially the same appearance. This appearance will ideally be an accurate reproduction of the appearance that industry standards dictate for the corresponding data value.

In order to achieve these ideals, a great deal of attention is paid to design and calibration. Printers are set up and controlled so as to achieve a predetermined nominal appearance of the printed output media from a given input data value. The range of colors actually produced may be affected by additional criteria, not limited to the color data, software drivers and print actuators, such as the choice of print media. The nature of the paper and the pigments or inks used can have an effect. Environmental conditions such as heat, humidity, and the like, may affect the output of which the printer is capable. In order to achieve the greatest possible range of output colors, and to accurately reproduce nominal colors, printers are calibrated. Thereafter, the printer may be monitored to maintain its calibration.

The capability consistently to produce an output having a defined set of color attributes, from nominal input data defining those attributes, is important to the basic usefulness of printers in data processing systems. This dependable and repeatable ability to obtain a desired nominal output from a given input enables the sharing of graphic image files among users of different printers, while achieving substantially the same display or print production results.

Calibrating a color printer or other color graphic output device may require the technician or user to align and to balance plural color output devices. Printer control programs for color printers often can produce test patterns that exercise the available gamut of color output combinations. The test pattern produced by a printer, or an area of the test pattern, is compared against a standard color swatch. If necessary, the operation of the printer may be adjustable for tweaking the printer to more accurately produce a portion of the test pattern. Calibration to a number of standard swatch colors that encompass a wide range of the gamut of possible colors, generally calibrates the printer. These adjustments might be made in the software or the hardware, i.e., in a driver that converts input data values, which are based on nominal ideals, to actual control of the output device, or in the output device itself.

There are any number of possible variations on these general attributes. For example, a data file stored on or generated by a digital processor, may wholly or only partly define the color characteristics of each picture element or pixel in a field to be printed. It is possible that the stored file can define all the elements, or a combination of stored data and generated data can be involved, for example as in the case where part of the output is determined by a character generator or by overlaid portions of an output or the like. In any event, a particular output appearance is expected in response to a given input.

Printers having some capability of calibration to achieve a nominal visual effect, for example to duplicate standard nominal color swatches when printing standard calibration test color patterns, are disclosed, for example, in U.S. Pat. Nos. 5,704,021—Smith et al.; 6,034,711—Trask et al. These calibration arrangements invariably conform printer operation to nominal color references. They are not meant to permit the user to vary operation of the printer for any reason that might interfere with previous calibration of the printer and its ability to produce nominal visual color presentations when printing nominal defined color data files.

Notwithstanding efforts to standardize color management, and notwithstanding all the variability in the color data that might be desired for artistic or other purposes in a color data file, it would be advantageous to provide a user with a control whereby the user can depart from normal color management controls. It would also be advantageous to distinguish between this function and calibration of a printer to produce a nominal output color. That is, it would be advantageous to provide a user control that does not interfere with or ruin the nominal calibration of the printer that produces standard colors from nominal color data values, while allowing the user to temporarily override the calibrated operation of the printer when desired to achieve certain visual output effects.

### SUMMARY OF THE INVENTION

A visual output system responsive to an input for producing an intended graphic output has a print mechanism with at least one controllable applicator operable to apply at least one color to at least a predetermined area of a medium to be printed. A controller is coupled to the applicator, the controller being responsive to the input to cause the applicator to produce on the medium a replica of the intended graphic output. The replica thereby produced on the medium as the actual graphic output is related to the input. A user-operated control input is coupled to at least one of the primary input, the print mechanism and the controller.

The user-operated control input is used to modify a relationship of the primary input to the actual graphic output. This permits the user to cause the graphic output to differ from the otherwise nominal output, upon user command.

If the printer or other visual output system has a stored calibrated color definition, the user-operated control input affords the user versatility to adjust the output, for example for artistic reasons, or to compensate for environmental, hardware or colorant supply variations.

The invention concerns the method of printing with user control, a system incorporating such capabilities, and devices that are so equipped. The invention is particularly applicable to a network or desktop color printer, and is aptly configured whereby the user-operated control input can selectively vary at least one of brightness, contrast, color density and hue.

### BRIEF DESCRIPTION OF THE DRAWINGS

The drawings depict certain exemplary embodiments, the same reference numbers being used throughout the figures to identify the same elements. In the drawings,

FIG. 1 is a schematic perspective view showing the elements of a printing arrangement according to an embodiment of the invention.

FIG. 2 is a detail view showing an exemplary control panel arrangement according to an embodiment of the invention.

FIG. 3 is a schematic illustration of graphic image data flow and the user control operation according to an embodiment of the invention.

FIG. 4 is a flowchart illustration of operations associated with an embodiment of the invention.

FIG. 5 is a schematic illustration of operational elements that are coupleable to user controls according to an embodiment of the invention.

### DETAILED DESCRIPTION OF THE INVENTION

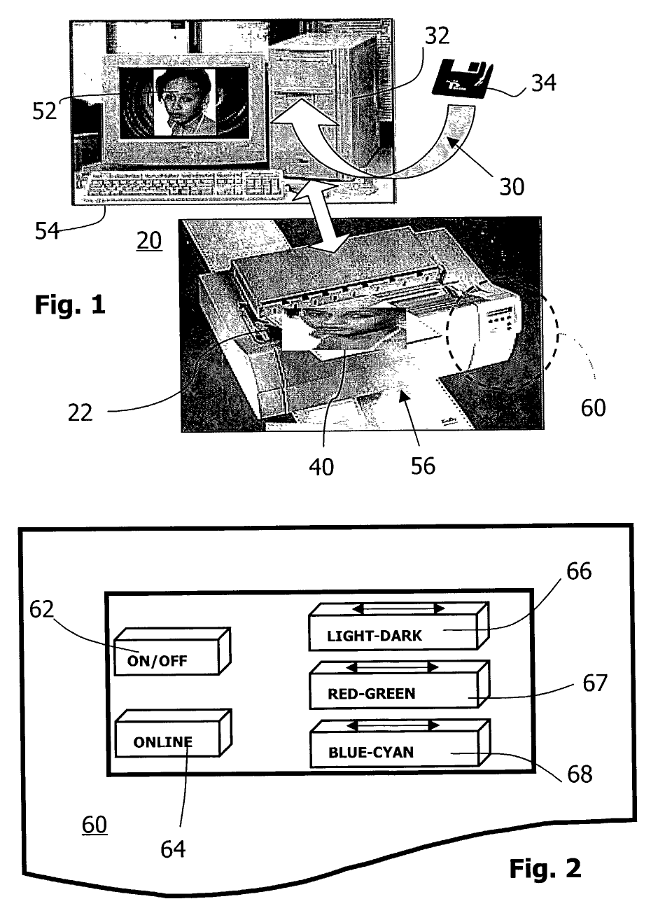

FIG. 1 illustrates an exemplary data processing system 20 for handling graphic data whereby a visual graphic output 22 is obtained directly or after processing, from data 30 that is loaded into or generated by a data processing device 32. The example shown is a desktop PC; but it should be appreciated that there are a variety of possible arrangements involving devices that produce visual graphic output.

In the example, a storage medium 34 such as diskette is assumed to contain a graphic image file, a program for generating graphic image data or for passing along image data from another source, or a combination thereof. The image data is transmitted or loaded into the data processing device 32 of data processing system 20, or is produced by the data processing system 20. The data processing system 20 optionally has a display device 52, a user keyboard 54 or similar control for preliminarily viewing the graphic output on a screen, and likewise can have other conventional peripherals.

A printer 56 is coupled to the data processing device 32 of data processing system 20, and is operable to produce a graphic output 40, such as a printed hard copy sheet 22. The image contained in the graphic output 40 is based upon the data generated or obtained from the input data 30.

The printer 56 is provided with manual controls 60 for altering the correspondence between the image that is actually produced as the graphic output 40, and the image that would otherwise be produced because it is the nominal resulting image defined by the graphic input data 30 and/or generated by operation of the data processing system 20 that controls the output.

FIG. 2 illustrates an exemplary arrangement for user controls 60. In addition to power on/off control 62 and an online/offline control 64, the printer 56 is provided with graphic output controls 66, 67, and 68 for altering the nature of the output that actually is produced, from the output that otherwise would have been produced. That is, although the system 20 is typically calibrated such that the graphic image 40 corresponds closely to an ideal defined by the input file 30, the system 20 provides a user-selected avenue to alter the output so as to differ from the nominal, ideal and/or calibrated output, if the user so selects.

In the exemplary embodiment shown, the controls 60 comprise a light/dark control 66 for generally increasing or decreasing the brightness of the ultimate output image, and two color balance controls 67, 68 for shifting the point of balance between two paired colors. That is, the color balance controls can shift the nominal color difference midpoint of hue from a calibrated midpoint toward one of two paired colors such as red/green or blue/cyan. The color balance controls thereby bias or tinge the output more toward one of the paired colors and away from the other.

These user image controls as provided in FIG. 2, are exemplary rather than limiting. As opposed to controls for brightness and color difference, for example, the controls could concern brightness, saturation and hue. In that case, saturation can be equated with color depth or density. Hue is construed to encompass a selected color wavelength from the palette of all available colors in a spectral range, independent of brightness or color density.

An alternative user-selection set of possible controls could alter the gain or bias applied to the driving signals to the individual color applicators (not shown in FIG. 2) whereby three or more color outputs are combined. That is, separate gain and/or offset adjustments can be provided for each of red, green, blue (or cyan, etc.) to obtain the output. In any case, the printer 56 is controlled internally and/or by data presented to the printer 56 by the data processor 32, to control the color applied to each point or pixel or other field defined on the sheet that is printed or similarly produced as the graphic output 22.

The alternative controls such as brightness-color difference, or brightness-saturation-hue, or color component gain or offset, etc., provide for user control of the correspondence between the color space definitions of the input data values in input file 30 and the color that actually is applied to the pixels in the graphic output 22. This control permits the user to alter the nominal color output for any reason.

The invention permits a user to control the output of a printer 56, for example, to effect artistic choices. For this purpose, the user may wish to produce an output that is shifted toward or away from a given color. The control permits the user to vary printer operation out of standard calibration, even while the printer 56 otherwise is calibrated and/or capable of calibrated operation.

On the other hand, the user may wish to control the output of the printer 56 manually to overcome some other effect that adversely affects the calibration or apparent calibration of the printer output. A desirable change could be wholly or partly subjective on the part of the end-user, or could involve a change to offset some condition of data collection or processing or output. For example, photos taken late in the afternoon, if accurately recorded, are likely to appear more yellow than a similar scene taken earlier in the day, simply because the ambient light is affected by the setting sun. Aged photographic paper may have a sepia tone. Further, the print media may vary according to certain characteristics such as moisture content, surface roughness, and surface resistivity, for example, which may affect the colors produced.

According to the invention, the user is not bound to accept the normal operation data processor and printer and the results of their image producing arrangements, even if they are freshly and accurately calibrated. The user can employ the controls provided to differ from calibration, to insert an effect or to remove an effect. Preferably, the user's controlled variations are accomplished without interfering (or perhaps only temporarily interfering) with any calibration arrangements of the printer and/or data processor.

Calibration concepts assume that the input data 30 conforms to a calibrated color standard, and that the primary object is accuracy. According to the invention there is a capability for the user to control the output, but color calibration accuracy is nevertheless preferably retained, e.g., as a default operational condition of the printer 56 that can be resumed readily.

Color calibration techniques based upon industry standards may still be employed, such as printing from files containing standardized color calibration data, comparing test printed data to swatches that are known to be calibrated, and if necessary adjusting a stored color space correspondence matrix definition or other mapping of color spaces that is stored in the data processor or printer, or is inherent in their normal operation, so as to produce the colors expected from predetermined data. The invention does not preclude such calibration, but permits the user to differ from strict compliance with the calibration, when desired.

The user might wish to alter the color calibration correspondence of a printer 56 or other output device to overcome an anomaly that has caused the printer calibration to become inaccurate. For example, if a printer provides pixel colors by proportionate mixing or combining of primary colors, for example from ink jets (not shown), the composite output can be affected by an imbalance in the operation of the ink feeding and controlling devices. Assuming for example that one color output becomes temporarily partially occluded, it is possible to overcome this problem by the user changing the balance at which the printer is driven by the data processor, to simulate calibrated operation in the absence of the problem.

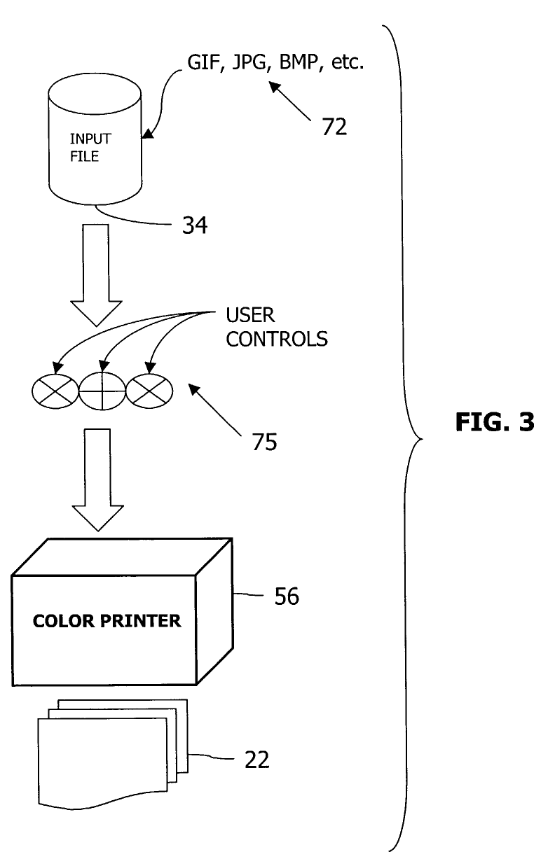

An exemplary embodiment of the invention, shown in FIG. 3, is arranged such that the input data is provided in the form of graphic standard image definition files 72. There are various possible file formats and image definitions. Some of these entail extensive industry standardization. These include, for example, Graphic Interchange Format (GIF), Joint Photographic Experts Group color image format (JPG), tagged image file (TIF), individual pixel bitmapping (e.g., Microsoft BMP), vector graphics (e.g., AutoCAD DXF), various proprietary and wordprocessor formats, etc. In addition, these ideal graphic file definitions are subject to extensive calibration procedures intended to improve the probability that the same data will produce a graphic output that is substantially identical in appearance, regardless of the printer used to print the data.

Between the input file 30 and the graphic image output 40, namely the hard copy color-printed item from color printer 56, certain user controls 75 are operated to alter the manner in which the input file 30 would otherwise be processed to produce the output 40.

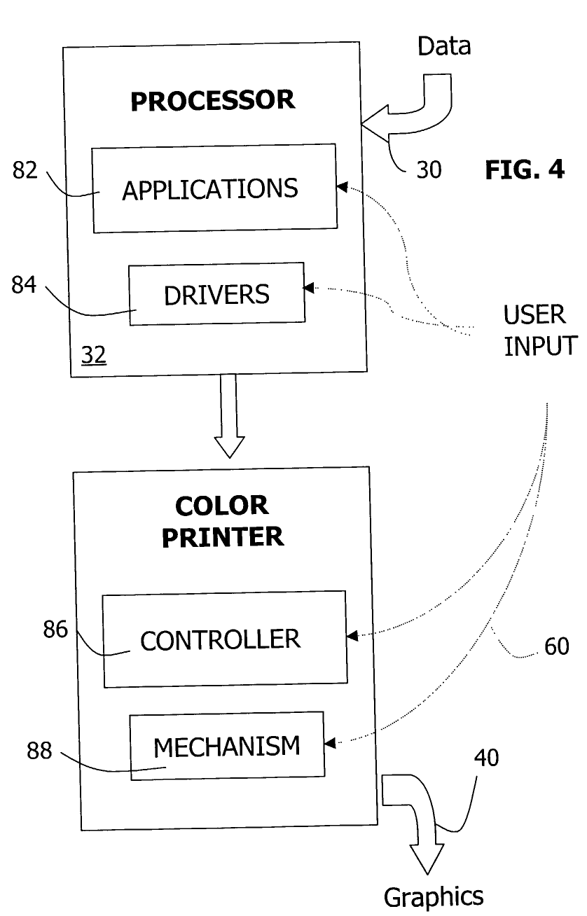

FIG. 4 illustrates the progress of the graphic information from a source such as input file 30 to the graphics output 40, e.g., a hard copy printed sheet. The data is applied to or generated by a processor 32. Typically, the processor 32 runs an operating system and applications programs 82 within the operating system. The applications programs generate print data. The print data at least partly defines the image to be produced, according to some standard (e.g., GIF, JPG, BMP, etc.) at least over some defined area of the graphic output 40. The processor 32 could be programmed for any number of different image coding standards, but the standard that is used to generate print data for the image contained in a given data file, of course, is the same standard that was used when the image was encoded.

One of the programs that normally runs under the operating system and is responsive to the applications programs is a peripheral driver program 84 associated with the printer 56. The driver 84 takes the output data of the applications program 82 as its input, and places this data in the corresponding format acceptable to the printer 56 or other similar graphic output device. The driver program produces a signal that is coupled to the printer and induces the printer to print, namely to feed the paper or other media and/or to displace a printhead and/or to apply pigment, dye, toner, heat or some other effect to the output media, directly or indirectly, so as to cause the required visible effect (e.g., text characters and graphic shapes and colors).

The color printer 56 has operational elements, generally represented as a controller 86. The printer 56 receives the data from the driver 84 and operates graphics forming mechanisms 88 such as print heads, impact devices, fluid jets, thermal applicators, ink or toner applicators, etc., in coordination with a paper feed or movable print head actuator (not shown).

The user's controls 60 according to FIG. 2 are mounted on the printer 56. As shown in FIG. 4, the user input can alternatively or additionally be coupled to, mounted on or otherwise applied to one or more of the processor 32 (at the applications program 82 or the driver(s) 84), at the printer controller 86 or at the driven printer mechanism 88 of the printer 56. In each case the user input functions to revise what would have been the normal output, e.g., a calibrated output, to achieve a desired departure from calibration at the user's discretion.

The user-operated control input 60 can, by programming and/or by switching arrangements, apply to a particular print job only, and after the apparatus generates a graphic output, the apparatus can revert to nominal operation until the user-operated control input 60 is activated again. Alternatively, any alteration from a given state (e.g., calibration) can remain active until manually changed or switched off. In an arrangement as shown in FIG. 2, wherein the user controls 60 comprise switch inputs used for making adjustments, it is possible to have the adjustments reset to a calibrated condition via a reset switch (not shown) or by operation of the online/offline switch 64, or upon power up.

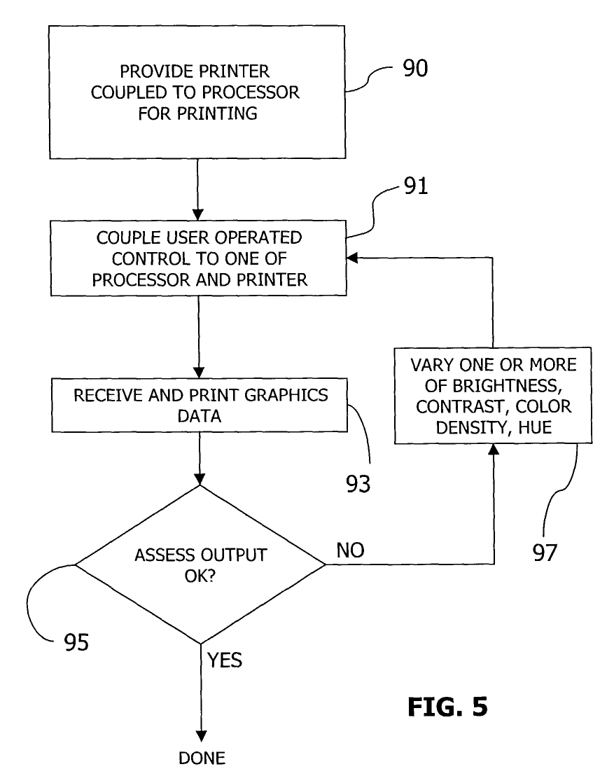

Referring to FIG. 5, it is normally necessary for the user to monitor the output in order to determine the extent of alteration to be employed and to assess whether previous alterations have produced the desired effects. In such an operation, the system 20 is equipped as described (block 90) including a processor coupled to a printer or similar output device. User controls 60, 75 are likewise coupled to the printer 56 and/or processor 32 associated therewith (block 91), normally as a part of the control inputs to the printer, either at the printer 56 or through controlling software 82, 84 provided at the processor. The system receives and prints an image at least partly corresponding to graphic data (block 93). The results are viewed and assessed by the user (block 95). If the assessment suggests to the user that other changes are desirable, at the user's option, the controls are adjusted, e.g., incrementally in the direction desired (block 97). If necessary, such operations can be repeated in iterative steps to approach the desired effect.

In this manner, the invention improves visual output systems that produce a graphic output, by enabling the user to alter operation so as to diverge from operation that would otherwise simply reproduce, insofar as possible, the input data according to the existing potentially-calibrated state of the apparatus.

As shown in FIGS. 3 and 4, the user controls and/or their effects can be interspersed at various points between the incoming or generated graphic data files and the ultimate graphics output. For example, the user controls can vary the operation of: the applications programs that produce output data; the printer driver routine that conforms the output to the printer mechanism; and/or the controller of the printer or operation of the mechanism by which the printer physically produces the output. The controls can be level controls, incremental bump-controls to increase or decrease a setpoint, or continuous controls, for example comprising potentiometers, or in some cases physical adjustments of mechanical parts that affect colorant supplies and/or feed rates. Thus the control can provide an input to a software function by which the user input alters operation of the controller, or the user input can physically affect the controlled device.

In a preferred arrangement, the user-operated control is associated with the printer and comprises an input device. The user-operated control can be coupled to the printer or print mechanism, or can be arranged to provide an input that is employed by a controller in the printer or in the processor, as shown in FIG. 4, to alter the correspondence of the input data to the graphics output, under the user's control.

The invention is applicable to various forms of visual output systems, but is most apt for a color printer system, for example on a network printer or a local printer coupled to a PC. Thus the system includes a processor responsive to an input defining at least an aspect of an intended graphic output, and a print mechanism having some form of controllable applicator to present a variable image, especially in color, over a predetermined area of a medium. A user-operated control permits user selection of a point in a range of color balance, or an incremental change in a range of color balance, for example whereby the user can change one or more aspects such as the color density, the image brightness, the balance or offset between colors, or other similar factors that determine exactly how the image presented on the medium corresponds to the variable input that otherwise defines the graphic output.

Operationally, the invention is practiced by coupling a printer or similar output device to a processor that produces controlling signals in response to input data for an intended graphic output, providing a user-operated input to at least one of the printer and the processor, and controlling them so that the ultimate output produced by the applicator of pigment or ink or toner or the like, varies as a function of the user-operated input, instead of being produced only in an invariable, e.g., calibrated manner.

The invention having been disclosed, additional variations will become apparent to persons skilled in the art, in view of this disclosure. The invention is not intended to be limited only to the illustrative examples discussed above. Therefore, reference should be made to the following claims rather than the disclosure of examples, in order to assess the scope of the invention in which exclusive rights are claimed.

What is claimed is:

1. A visual output system responsive to an input for producing an intended graphic output, said visual output system producing an actual graphic output, the system comprising:
a print mechanism having at least one controllable applicator operable to apply at least one visual effect to at least a predetermined area of a medium to be printed;
a controller coupled to the applicator, the controller being responsive to the input to cause the applicator to produce on the medium a replica of the intended graphic output, the replica thereby produced on the medium as the actual graphic output being related to the input; and,
a user-operated control input coupled to at least one of the input, the print mechanism and the controller, for modifying a relationship of the actual graphic output to the input.

2. The visual output system of claim 1, wherein the visual effect comprises a color.

3. The visual output system of claim 1, wherein the input at least partly comprises a data file according to a standardized image definition format.

4. The visual output system of claim 1, wherein the controller generates a data file according to a standardized image definition format, and wherein the data file at least partly controls operation of the applicator.

5. The visual output system of claim 1, wherein the print mechanism comprises a color printer and the user-operated control input selectively varies at least one of brightness, contrast, color density and hue.

6. The visual output system of claim 5, wherein the user-operated control input selectively varies a balance between at least one pair of colors.

7. The visual output system of claim 5, wherein the user-operated control input selectively varies proportions of colorants applied to areas at which at least two said colorants are applied.

8. The visual output system of claim 1, wherein the user-operated control comprises a software function by which the user input alters operation of the controller.

9. The visual output system of claim 1, wherein the user-operated control comprises an input device coupled to the print mechanism to alter operation of the applicator.

10. A color printer system, comprising:
a processor responsive to an input defining an intended graphic output;
a print mechanism having at least one controllable applicator operable to apply at least one visual attribute to at least a predetermined area of a medium to be printed;
a user-operated control input for user selection of at least one of an operating point in a controllable range of the visual attribute and an incremental change to a current operating point in said controllable range, the user-operated control input being coupled to at least one of said processor and said print mechanism;
wherein the processor and the print mechanism are operable to produce an actual graphic output that is nominally equal to the intended graphic output;
wherein at least one of the processor and the print mechanism is operable in response to the user-operated control input to alter a correspondence between the intended graphic output and the actual graphic output.

11. The color printer system of claim 10, wherein visual attribute includes color and the user-operated control alters the actual graphic output as to at least one of brightness, contrast, color density and hue.

12. The color printer system of claim 10, wherein the print mechanism comprises a color printer.

13. The color printer system of claim 12, wherein the user-operated control input comprises an input device located on the color printer.

14. A method for providing a visual output responsive to a data input that defines a nominal graphic output, comprising the steps of:
coupling the data input to a print apparatus operable such that the visual output responsive to the data input substantially conforms to the nominal graphic output;
coupling a user-operated control input to the print apparatus, and varying said control input so as to cause the visual output to vary from the nominal graphic output, based upon said user-operated control input.

15. The method of claim 14, wherein the data input defines at least one color attribute and the user-operated control varies a color relationship between the visual output and the nominal graphic output by affecting operation of the print apparatus.

16. The method of claim 14, wherein the print apparatus comprises a color printer and the control input is varied from an input on the print apparatus.

17. The method of claim 14, wherein the visual output is varied from the nominal graphic output with respect to at least one of brightness, contrast, color density and hue.

18. The method of claim 17, wherein the control input is variable to alter a point of balance between two distinct hues.
